(19) United States
(12) Patent Application Publication
(10) Pub. No.: US 2005/0004938 A1
(43) Pub. Date: Jan. 6, 2005

(54) Conference management method, system and data structure

(76) Inventor: Helmut Koenig, Erlangen (DE)

Correspondence Address: HARNESS, DICKEY & PIERCE, P.L.C., P.O.BOX 8910, RESTON, VA, 20195, US

(21) Appl. No.: 10/882,237

(22) Filed: Jul. 2, 2004

(30) Foreign Application Priority Data
Jul. 3, 2003 (DE) 10330078.3

(51) Int. Cl. G06F 7/00; G06F 17/30; G06F 17/00

(52) U.S. Cl. 707/103 Z

(57) ABSTRACT

A method, a system and a data structure are for organizing, preparing and/or carrying out a computer-aided conference. The subject of the conference is preferably in the medical field and the conference is based on image data and document data. Data which are relevant to the conference are automatically sought, possibly selected, transformed, displayed and stored in the data structure. During the conference, only the generated data structure is now accessed. The data structure may be stored in a conference data memory.

The present application hereby claims priority under 35 U.S.C. §119 on German patent application number DE 103 30 078.3 filed Jul. 3, 2003, the entire contents of which are hereby incorporated herein by reference.

### FIELD OF THE INVENTION

The invention is generally based in the field of digital conferences and relates in general to improvement and even optimization of the procedural and, in particular, image processing processes. It relates in particular to the automated preparation of clinical conferences on the basis of findings data which have already been stored in a system and include, inter alia, two- and/or three-dimensional object data.

One fundamental area of application for the present invention is in the field of clinical conferences with medical data, preferably image data, e.g. in the form of X-ray images or CT images and the associated findings data.

### BACKGROUND OF THE INVENTION

Particularly when planning the treatment of patients with an unusual complaint or an illness profile which concerns a plurality of disciplines, it has been found to be necessary to call a medical council in the form of a conference in order to sort out the facts with other colleagues in the team. This should also be possible between a plurality of buildings—that is to say with a physical distance between the conference participants. From a technical point of view, this requires central processing of conference-related and/or other relevant data in distributed systems.

DE 199 32 964 discloses a method for processing image data and object-related information data in which the image and information data available in different data formats are converted into one common data format. This means that image and information data which are associated with one another can be combined and stored in a common information complex.

With complex clinical pictures, however, whose diagnosis and/or treatment is/are based on a plurality of findings data, it is appropriate and necessary to bring together all of the data which have already been collected first so as to permit central processing.

This presupposes that data which have been recorded and stored in the past are now automatically identified as relevant data and are found.

In practice in clinical operation, the data have been stored in various formats at different locations. Frequently, the clinical picture requires the use of various diagnostic methods or approaches, such as X-ray, computer tomography, magnetic resonance and positron emission tomography (PET).

U.S. Pat. No. 6,523,029 discloses a method for free-text searching in which the search text, which can be input by the user as desired, is first transformed into sentences. The sentences are prioritized using their content, and sentences having a relevant content are transformed into search queries for various sources of information. The various search results are stored locally, with the search results being assessed by the user in order to improve the search quality.

However, one technical problem of processing all of the relevant data centrally can be seen in that the image data recorded using the different approaches may also have different forms and dimensions which allow them to be processed together only under particular technical assumptions.

During a conference, it is necessary to be able to access all relevant data. In this case, the time required for loading and displaying the data on a visual display unit or screen should be as short as possible in order to avoid blockade times, caused by data access, loading and/or image setup. If, by way of example, a patient needs to be discussed with his clinical picture, then at least a selection of his findings data and possibly a CT image and also additionally, by way of example, an X-ray image need to be displayed. Image setup in the case of known applications has been time-consuming to date and is based on a multiplicity of processes running in the background. In previous systems, this was disadvantageously, if at all, possible only with long blockade times.

To date, the conference participants have been tied to a sequential procedure on account of the data structure(s) available: by way of example, the findings data and the CT image for a patient have been loaded and displayed on the screen. If it has then turned out to be necessary during the conference to consider other findings data and/or other image data as well—e.g. a CT image of the same region of the body which was taken earlier—in order to be able to establish changes over time, for example, then the participant has first needed to search for this earlier image, to transform it, possibly manually, into a displayable and suitable format and then to structure it such that it has also been possible to display other data, for example the associated findings data, on the screen. That is to say that the change from one screen display (for image data) to another has been very time-consuming. In addition, the retrieval, that is to say the search for and procurement, of the data to be evaluated has required a high level of concentration, since the search queries have needed to be generated manually.

### SUMMARY OF THE INVENTION

This previous procedure can be significantly simplified, shortened and automated using an embodiment of the present invention.

This may result in an advantage that the conference participant now no longer needs to direct his attention to procuring the data, but rather can concentrate exclusively on analysis, commenting on existing findings and reanalysis.

In addition, it is possible to ensure that all of the relevant data for a case are found as well. The automated search in a database makes it possible to prevent data records, e.g. older images of the same patient, from being overlooked. This also increases the certainty of the system and of the (re)analysis.

In addition, it is very advantageous in practice that an earlier interpretation or analysis of an image of the patient can also be modified again on account of further results and that this modification or reanalysis can also be stored together with the object data. From a technical point of view, this is the first thing to permit central processing.

All data which are relevant to the assessment can advantageously be displayed simultaneously. The conference participants actually have all of the relevant data in front of them at the same time and do not need to rely on their memory.

An embodiment of the invention relates to clinical conferences. Alternatively, an embodiment of the present invention may also be used for conferences of any type which are based on an assessment of various data records, such as the evaluation of geographical data or other digital image data in the field of robotics or production.

In one embodiment, the invention relates to the automated search for and/or the generation of a data structure for the purpose of organizing, preparing and/or carrying out a conference in the medical field. The data can be classified, firstly, into image data and, secondly, into document data. Image data may be X-ray images, CT images or the like. The term document data relates to findings data in general. The data structure permits all data—both image data and findings data—to be displayed for a case in optimum fashion. Another application relates to other three-dimensional, digitized data or moving pictures.

In order to simplify the navigation in the relevant data records, the invention additionally includes a directory service and a specific directory structure.

So that the access times to the data records and hence also the time for image setup can be shortened further overall, provision is optionally made for the relevant data to be stored locally. Preferably, the data for a patient are combined in a file or in a file structure.

It is therefore an object of an embodiment of the present invention to provide a method, a signal processor, a system and a data structure which permit(s) central processing of all relevant data for a —preferably clinical—conference and which allow(s) automated retrieval of all relevant data, at least some of which may be stored in distributed fashion. The intention is also to permit a division of time into a conference preprocessing phase and a conference real time phase, so that as many method steps as possible can be brought forward to the preprocessing phase and no longer need to be executed in real time.

This object may be achieved by a method, preferably for the automated retrieval of data, at least some of which are stored in distributed fashion, and/or for generating a data structure for data which are to be evaluated, for the purpose of organizing, preparing and/or carrying out a computer-aided conference, comprising the following method steps:
all relevant data are sought and a set of relevant data is generated,
data to be evaluated are selected from the set of relevant data, and
the data structure is generated by transforming the data to be evaluated.

An embodiment of the invention also may achieve this object by way of a signal processor.

The data structure and a conference management system may also be designed to achieve this object.

An embodiment of the invention may achieve an advantage that the method steps can be divided into those which can be executed in advance or in the conference preprocessing phase, i.e. before the conference is carried out, and those which need to be executed in real time—that is to say during the conference. This allows the processing time during the conference to be significantly shortened and allows waiting times to be reduced or even minimized.

The search for the relevant data, the selection of data to be evaluated and the generation of the data structure are performed in the conference preprocessing phase. In line with an embodiment of the invention, only the display of data to be evaluated or at least portions thereof is executed in real time. This results in the significant advantage that the conference participants can react much more quickly during the conference and have a significantly increased level of variability, in comparison with the procedure based on the prior art. They can alter the search criteria and are provided very quickly with a different screen display which—on account of the short loading time—they can still compare with the old display, for example.

Advantageously, data which are to be evaluated and/or are relevant are now accessed during the conference only using or for the generated data structure.

In line with an embodiment of the invention, a multiplicity of method steps are “brought forward” to the conference preprocessing phase. Hence, the data structure is generated in the conference preprocessing phase and only access to this data structure is effected in real time.

The selection of data to be evaluated from the set of relevant data is performed as an option. That is to say: it is also possible for no selection or a full selection to be performed, which means that the entire set of relevant data is evaluated or is supplied to an evaluation unit.

Particularly in the case of image data or image data records, however, provision is made for the selection to be performed. Besides the image data per se, image data records include a header storing properties of the respective data (depending on the underlying standard, this may be the size of the file, the time of storage, the recording location, etc., for example). The image data records are stored in entities or series in order to allow all data records associated with an examination to be combined.

Thus, by way of example, all sectional photographs from an examination are stored in one entity. An embodiment of the invention makes provision for not all of the headers in all of the image data records in an entity to need to be analyzed in principle, but rather preferably only the headers from an entity or series which is to be evaluated. Thus, by way of example, only the image data which have been generated on a particular day in the course of a particular examination are processed further.

The search for all relevant data is preferably performed automatically. However, it is also possible for the respective conference participant to engage in this operation in order to filter out particular data records directly. If the search is to be performed automatically, then an embodiment of the invention involves particular search queries being generated automatically. These search queries are generated according to predetermined criteria or constraints.

Thus, by way of example, there may be a preset specifying that, in the case of a radiological conference, at least the radiological data are classified as relevant and are supplied to a further processing stage. By way of example, laboratory data may therefore be masked out for the rest of the method as irrelevant.

Advantageously, the criteria which are required for automatically generating search queries and for selecting the relevant information, e.g. constraints, type of conference, its subject, participating units, etc., are recorded as conference properties in a conference rule memory.

To date, it has not been necessary to collect the relevant data for a conference manually, so to speak. They have sometimes been situated “nonlocally” and have been stored in another system. There has also been the difficulty of combining various data records with one another when some of them are available in different formats (e.g. PET image data and anamnesis data). This is solved by an embodiment of the invention by virtue of the data to be evaluated being supplied to a transformation stage which, in one advantageous, alternative embodiment of the invention, also comprises a conversion stage. The data structure generated advantageously permits central display and/or processing and/or local storage of the data which are to be evaluated.

The data structure is generally created by transforming the data which are to be evaluated. The transformation preferably relates to case-specific structuring of the data which are to be evaluated. If the intention is to discuss a patient's therapy success, for example, then it is fundamental for all or at least some image data for the same region of the body to be displayed and compared with one another. In this case, it is necessary to structure the data, which allows simultaneous representation of the image data on the screen. In addition, there is the time constraint that only data which are chronologically after the start of treatment, on the one hand, and after the end of treatment, on the other, are processed. Other data are not necessary for this case and are also not processed, since they would result in the process being slowed down.

One preferred embodiment of the invention relates to a conference management system which permits a conference between participants at different locations—that is to say between various organizations and buildings. This presupposes protective mechanisms which provide secure data transfer via the underlying network. An embodiment of the invention safely prevents patient-specific data from being tapped off externally without authorization.

As an alternative to the application which has just been described, the inventive system may also be used within an organization only, which means that additional protective measures are not necessary or may be used only as an option.

The inventive separation of method steps which can be performed as preparatory measures and those which need to take place in real time makes it possible to minimize the waiting times which arise as a result of loading and/or searching for image data, for example. The inventive data structure is therefore designed such that the data records which are to be evaluated in the conference can be read from the memory very quickly. In addition, the data structure permits efficient and easy searching for particular data by providing associations.

One advantage can be seen in that the retrieval or the search for the relevant data, the selection and/or the transformation is/are performed automatically.

In order to speed up the loading of data further, one alternative embodiment of the invention provides for the data which are to be evaluated and/or the generated data structure preferably to be stored locally.

Optionally, provision may be made for the generated data structure to be displayed, at least in part, on the screen or for said data structure's abstract structure to be displayed for the purpose of overview.

Another, preferred embodiment of the invention includes an interface which allows the data in the generated data structure to be accessed externally in order to permit more extensive processing—e.g. by other application processes. Alternatively or cumulatively in this regard, provision is made for the data structure also to include links which point to data records comprising more detailed information regarding the respective entry. This results in the advantage that this detailed information does not necessarily need to be shown and/or stored together with the data which are to be evaluated, but rather only if required. This ensures the clarity of the data representation.

One alternative way of achieving the object is provided by a storage medium which is intended to store the computer-implemented method described above and can be read by a computer.

The above embodiments of the invention may also be produced in the form of a computer program product with computer program codes which can be prompted to carry out one of the above methods.

Other advantages, features and alternative embodiments of the invention can be found in the detailed description of the exemplary embodiments, including the figures below in which:

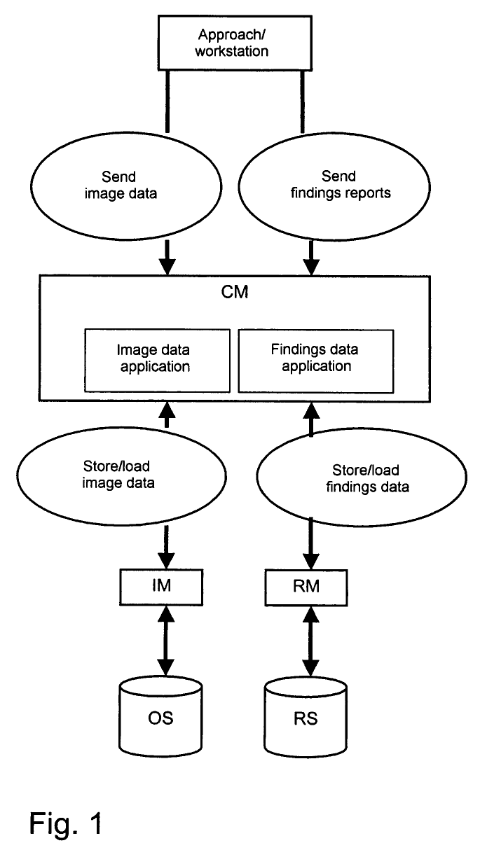

FIG. 1 shows a schematic illustration of a sequence in line with an embodiment of the invention in the form of a flowchart,

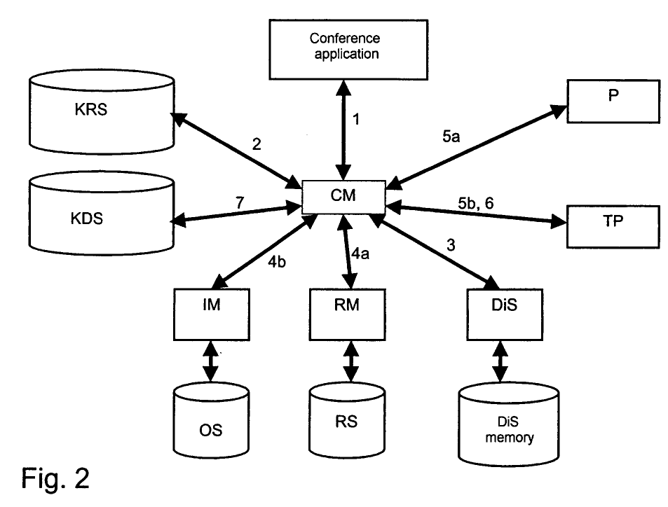

FIG. 2 shows a schematic illustration of an architecture in line with an embodiment of the invention,

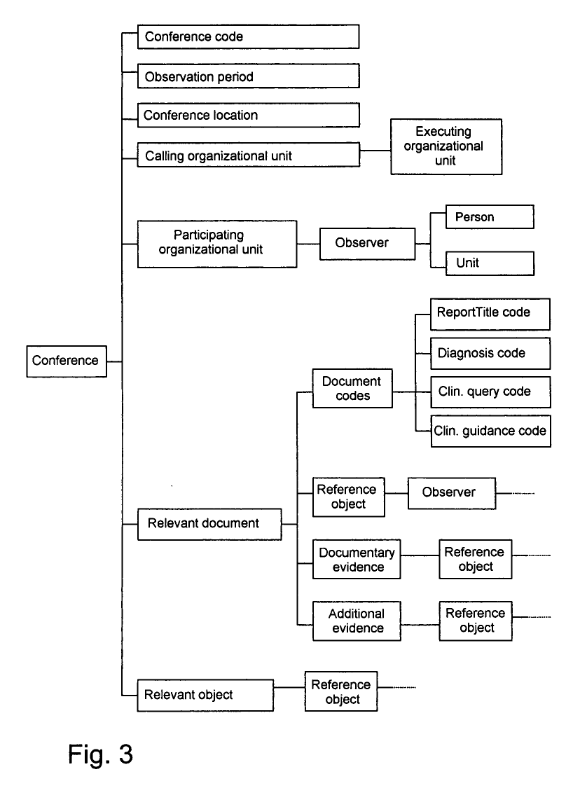

FIG. 3 shows a schematic illustration of a directory structure designed in line with an embodiment of the invention, and

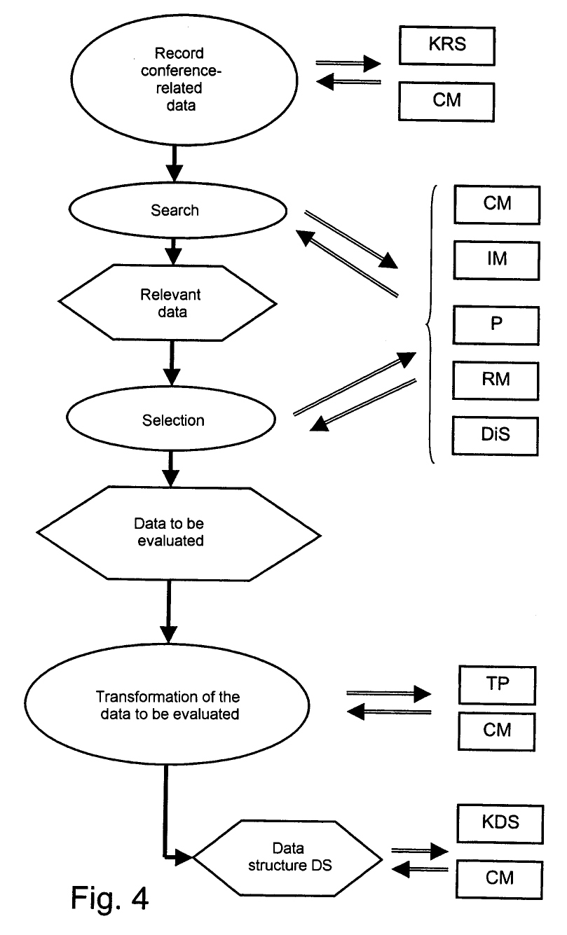

FIG. 4 shows an overview of the modules in line with one embodiment of the invention and the functional relationship between them.

### DETAILED DESCRIPTION OF THE PREFERRED EMBODIMENTS

FIG. 2 shows an overview illustration of modules based on an embodiment of the invention. As central processing unit, it includes a conference manager CM, which is designed for searching, for selection and for generating a data structure DS. This conference manager interacts with an image manager IM, a report manager RM, a directory service module DiS, a parser P, a transformation processor TP, a conference rule memory KRS and a conference data store KDS.

The image manager IM manages the image data and is able to interchange data with an object memory OS storing the image data, such as X-ray images, CT and/or magnetic resonance images and the like. The term object memory should not be understood in the physical sense in this case, but rather relates instead to a combination of diverse memory locations for image data. The term object memory should be understood to mean a reservoir for data, some of which may also be stored in distributed fashion and nonlocally. The image manager IM is based on an interface which is designed for communicating image and findings data. Preferably, this is DICOM (Digital Imaging and Communications in Medicine; DICOM) or HL7 (cf. in this regard HL7, Clinical Document Architecture Framework Release 1.0, 2000).

The report manager RM accesses a report memory RS. The term report memory should likewise not be understood to be physical, in the same way as the term object memory, but rather is intended to combine various memory locations for report data records. The report manager RM manages all of the findings data within the system.

The directory service module or the directory service DiS manages the data records which relate to the conference and/or to the organization or subunits thereof and/or to the employees therein. It contains a definition, by way of example, of the function or the role (doctor or IT specialist or physicist) of an employee within the organizational unit.

The parser P is used for reading-in at least portions of relevant data, preferably from the respective document and a respective image data header. For example, if the following problem is the subject matter of the conference: “Proposals for a continued course of therapy for patient X?”, then search queries such as “Search for all findings data and all image data for patient X” are generated. This search query is then applied to all recorded data or—if required, on account of efficiency considerations—to a section of these data (e.g. only data which have been recorded by a selected doctor as the analyzer).

The conference rule memory KRS stores properties and/or rules relating to a conference. The conference manager CM evaluates the conference properties recorded using the conference rule memory KRS. The conference properties evaluated can then be used for automatically generating search queries (e.g.: if the type of conference is “radiological”, initiate a search query with all radiological data).

The conference data memory KDS can then optionally be used to store the result of the inventive method and/or the generated data structure DS.

The timing for the inventive method is shown in FIGS. 2 and 4. In FIG. 2, the numbers on the arrows relate to the time sequence for the respective steps. Thus, the conference manager CM first records all conference-related properties from the conference application and the conference rule memory KRS, such as the type of conference, the subject thereof, participating units, etc. A look-up table can be used to read further conference-related properties from a further module.

Next, in a third step, the conference manager CM accesses the directory service module DiS in order to obtain a list of suitable analyzers.

In steps 4a and 4b shown in FIG. 2, the data already ascertained are then used to initiate queries to the image manager IM and the report manager RM. In steps 5a, 5b and 6, the data to be evaluated are sought and filtered if appropriate. This is done by accessing the parser P and the transformation processor TP. The parser P combines a selection processor and a search processor. Preferably, headers from the respective image data records are read in here and are examined for particular criteria (e.g. “Is this an X-ray image in the period between 2002 and 2003?”). Only the data which are to be evaluated are filtered out in this step.

The image data records produced by the acquisition of image data are stored in series according to the DICOM standard (e.g. all of the CT image data for an examination which took place on a particular day and at a particular time). In this case, it is advantageous to evaluate, by way of example, the header data from just one entity. Since the number of DICOM entities produced is continually rising, particularly in sectional image diagnosis, the invention provides for not all of the headers to be parsed.

This significantly increases the performance of the system, since data which are not relevant are not processed further. The data to be evaluated are then supplied to the transformation processor TP. This unit is intended to structure the data which are to be evaluated. The result is that the data structure DS is generated automatically.

The data ascertained in this way or the generated data structure DS is/are optionally stored in the conference data memory KDS in a final, seventh step.

These ascertained data can be accessed using referenced identifiers. The referenced identifier is a type of unique link or reference to the associated file.

However, it may be that, after this method step of searching, the relevant data found are not all important to the specific problem. In that case, it is optionally possible to start a selection which filters from the set of relevant data only those data which need to be evaluated for the specific problem. This minimizes the volume of data to be processed and the access times.

If such a selection is undesirable, then the method step can also be skipped. In this case, an embodiment of the present invention is characterized only by the following steps: searching for the data to be evaluated and generating the data structure DS.

In an embodiment of the invention, provision is made for the selection to be integrated into the search. In that case, the selection criteria are actually processed during the method step of searching. The search then actually delivers the data which are to be evaluated.

The data to be evaluated will normally include a plurality of files in different formats. In order to simplify navigation among these data, an embodiment of the invention generates the data structure DS, which permits simple orientation and searching amongst the data which are to be evaluated.

FIG. 3 illustrates the architecture of the data structure DS generated in line with an embodiment of the invention. The conference file made up in this way can ultimately be stored in the conference data memory. Optionally, provision is made for the referenced documents and object data to be stored locally together with the conference file. This permits short access times. Provision is also made for further, associated data to be stored locally.

The classes shown in FIG. 3 with the respective connections also depict the associations within the data structure DS. Thus, by way of example, an “observer” has an associated “person” and an associated “organizational unit” in which he works. The “relevant document” class comprises the subclasses “document code”, “referenced or reference object”, “documentary evidence” and possibly further “additional evidence”. The “document code” class is in turn subdivided into “ReportTitle code”, “Diagnosis code”, “Clinical Problem code” and “Clinical guidance code”. This allows a document or a finding to be sought on the basis of the following criteria: title of the finding, diagnosis, clinical problem and other criteria.

Using the inventive data structure DS, a radiological conference can be held by a radiological department, while other departments, such as internal medicine, participate. There is also the stipulation of which employees take which roles within the organization or the organizational unit. By way of example, the conference may be a radiological conference in which the calling organization is the diagnostic, radiological department in a hospital.

In this case, the participating organization is both the calling organization and internal medicine. In addition, the roles of the respective participants within the organization are noted (in this case, “resident” on the one hand and “monitoring physicist” on the other). Furthermore, the referenced identifier UID, the name and the status flags “Complete?” and “Verified?” are stored. These flags can be used to identify whether a findings report is actually complete or finished and has been verified by an employee who is superior in the hierarchy.

The data structure DS preferably contains the following associations:
association of the calling unit and the organizational units involved in the analysis and/or assessment with a conference type,
association between the relevant roles and the organizational units involved,
association between the relevant data types and a conference type,
association between the relevant status values for a data type and a conference type.

In this context, the term “organizational unit” relates to organizational subunits, e.g. in a hospital. These may be, by way of example, the laboratory, the radiological department, the nuclear medical department, etc. The term “role” relates to the role which an employee takes in this organization, such as “doctor”, “consultant”, “physicist”, “technician”, etc. The data structure DS can be used to ascertain which people from the organizational units involved are suitable as analyzers.

These associations are stored in the directory service DiS, which the conference manager CM accesses before accessing the object memory OS and the report memory RS and before searching for the data which are to be evaluated. This is shown in FIG. 2.

When the conference-related data have been recorded and during the ensuing search for all relevant data and/or during the selection of data which are to be evaluated from the set of relevant data, the conference manager CM accesses the parser P. While the data structure DS is being generated, the conference manager CM accesses the transformation processor TP.

The transformation processor TP builds on the data processed by the parser P and transforms them using the data which are supplied to it by the conference manager CM, e.g. about the parameters for the conference (e.g. the type of conference: a radiological conference, the conference location, the calling, participating and holding organizational units). It automatically transforms the data which are to be evaluated into the data structure DS, which is suitable or designed for the respective conference. This is shown in FIG. 4.

FIG. 4 shows the data interchange with the conference rule memory KRS in two directions. This also includes a possible refinement of an embodiment of the invention which lays emphasis on making the conference rule memory self-teaching. In that case, information, that is to say data, ascertained by the conference manager CM is also transferred to the conference rule memory KRS in order to generate new rules in this way.

The method steps shown in the flowchart in FIG. 4 all take place in the conference preprocessing phase. Up to and including the step of “storing the data structure DS in the memory for conference data”, all of the steps shown are performed as a preparatory measure and not in real time. Only the reading of the data structure DS—or sections or portions thereof—and the display of these data take place in real time.

FIG. 1 shows an advance method step in the conference preprocessing phase. Here, the data, preferably the image data and the findings data, are assessed. In this connection, “status flags” or status values are also assigned to the data. It is thus possible at this point to assign the status value “verified” to a findings report, for example, in order to be able to identify that this report has been accepted by a doctor who is superior in the hierarchy. It is also possible to assign the status value “complete” to a report. This is intended to identify that the findings report is finished and is not an interim result which is yet to be completed. These status values relate to a DICOM interface. Alternatively, other interfaces and/or other status values may also be defined, however.

As can be seen from FIG. 1, the image data may be examined and supplied to a post processing stage if appropriate after the data have been received from the different approaches (e.g. X-ray, CT, PET). The image data are stored in the object memory OS and the findings data are stored in the report memory RS. Normally, there are also always findings data associated with image data. If this is not the case, this report and hence the corresponding report data can be supplemented at a later time.

By setting the status values at an early time, it is possible to use the information encrypted in the status values. By way of example, it is thus possible to establish for which findings data there are still no reports or reports which still need to be verified.

The embodiments of the invention may be based primarily on two standards: DICOM and DICOM SR (SR for structured reporting) and also HL7 CDA (Clinical Document Architecture).

It should be stressed that the description of the components of the system which are relevant to the invention should not be understood to be restrictive in principle. In particular, it is obvious to a person skilled in the relevant art that the terms used are to be understood to be functional and not physical. Hence, some or all of the components may be produced using software and/or in a distribution over a plurality of physical devices. The cycles described above may also be executed internally.

Any of the aforementioned methods may be embodied in the form of a program. The program may be stored on a computer readable media and is adapted to perform any one of the aforementioned methods when run on a computer. Thus, the storage medium or computer readable medium, is adapted to store information and is adapted to interact with a data processing facility or computer to perform the method of any of the above mentioned embodiments.

The storage medium may be a built-in medium installed inside a computer main body or removable medium arranged so that it can be separated from the computer main body. Examples of the built-in medium include, but are not limited to, rewriteable involatile memories, such as ROMs and flash memories, and hard disks. Examples of the removable medium include, but are not limited to, optical storage media such as CD-ROMS and DVDS; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for at least one of automated retrieval of data, at least some of which are stored in distributed fashion, and for generating a data structure for data to be evaluated, for the purpose of at least one of organizing, preparing and carrying out a computer-aided conference, comprising:
searching for all relevant data and generating a set of relevant data;
selecting data to be evaluated from the generated set of relevant data; and
generating a data structure by transforming the selected data to be evaluated.

2. The method as claimed in claim 1, wherein at least one of the searching, selecting and generating of the data structure is performed automatically.

3. The method as claimed in claim 1, wherein at least one of the searching and the selecting of the data is performed automatically with the aid of an evaluation of conference properties which are recorded in a conference rule memory.

4. The method as claimed in claim 1, wherein at least one of the searching and the selecting is performed by accessing a parser, and wherein the transforming is performed by accessing a transformation processor.

5. The method as claimed in claim 1, wherein a directory service allows easy navigation in the generated data structure in optimum time.

6. The method as claimed in claim 1, further comprising at least one of the following steps:
displaying at least portions of the generated data structure; and
storing at least one of the data to be evaluated and the generated data structure.

7. The method as claimed in claim 1, wherein the data are medical data.

8. The method as claimed in claim 4, wherein data to be evaluated are selected from image data stored in various entities by supplying the parser only with image data from at least one entity.

9. The method as claimed in claim 1, wherein the searching is performed at least one of automatically and by manually generating a search query with predeterminable constraints.

10. A signal processor for at least one of the automated retrieval of data, at least some of which are stored in distributed fashion, and for generating a data structure for data which are to be evaluated, for the purpose of at least one of organizing, preparing and carrying out a computer-aided conference, comprising:
a parser, including a search processor for searching for all relevant data and for generating a set of relevant data and a selection processor for selecting data to be evaluated from the set of relevant data;
a transformation processor, intended to transform the data to be evaluated by generating the data structure; and
a conference rule memory.

11. The signal processor as claimed in claim 10, wherein at least one of the searching, the selecting and the generation of the data structure is performed automatically.

12. The signal processor as claimed in claim 10, wherein the signal processor includes a conference manager, adapted to interchange data with the parser.

13. The signal processor as claimed in claim 10, wherein the signal processor comprises:
a conference manager, adapted to interchange data with all other modules or elements in the signal processor,
a directory service module, and
a conference data memory (KDS).

14. The signal processor as claimed in claim 10, wherein the signal processor comprises a directory service which permits easy navigation in the generated data structure in optimum time.

15. The signal processor as claimed in claim 10, wherein the signal processor comprises at least one of the following modules:
display unit, intended to display at least portions of the generated data structure, and
memory module, intended to store at least one of the data to be evaluated and the generated data structure.

16. The signal processor as claimed in claim 10, wherein the data are medical data.

17. The signal processor as claimed in claim 10, wherein the selection processor is used for image data stored in various entities by supplying the parser only with image data from at least one entity.

18. The signal processor as claimed in claim 10, wherein the search is at least one of performed automatically and by manually generating a search query with predeterminable constraints.

19. A data structure for at least one of organizing, preparing and carrying out a computer-aided conference based on data which are to be evaluated, where an organizational unit calls the conference, an organizational unit holds the conference, an organizational unit has employees who take roles within the organizational unit, and where the data are occupied by at least one status value and can be classified into data types, having at least the following associations:
association between organizational unit and conference;
association between role and at least one of organizational unit and employee;
association between data type and conference; and
association between status value and conference.

20. A system comprising a signal processor as claimed in claim 10.

21. The method as claimed in claim 7, wherein the data include object data, including at least one of image data and biosignal data, and document data.

22. The signal processor as claimed in claim 11, wherein the signal processor includes a conference manager, adapted to interchange data with the parser.

23. The signal processor as claimed in claim 16, wherein the data include object data, including at least one of image data and biosignal data, and document data.

24. A signal processor for performing the method of claim 1.

25. A method for generating a data structure for data to be evaluated, for the purpose of at least one of organizing, preparing and carrying out a computer-aided conference, comprising:
generating a set of relevant data;
selecting data to be evaluated from the generated set of relevant data; and
generating a data structure by transforming the selected data to be evaluated.

26. A system for generating a data structure for data to be evaluated, for the purpose of at least one of organizing, preparing and carrying out a computer-aided conference, comprising:
means for generating a set of relevant data;
means for selecting data to be evaluated from the generated set of relevant data; and
means for generating a data structure by transforming the selected data to be evaluated.

27. A signal processor for generating a data structure for data which are to be evaluated, for the purpose of at least one of organizing, preparing and carrying out a computer-aided conference, comprising:
means for searching for relevant data, for generating a set of relevant data and for selecting data to be evaluated from the set of relevant data;
means for transforming the data to be evaluated by generating the data structure; and
a conference rule memory.

28. A signal processor for generating a data structure for data which are to be evaluated, for the purpose of at least one of organizing, preparing and carrying out a computer-aided conference, comprising:
a search processor for searching for relevant data and for generating a set of relevant data;
a selection processor for selecting data to be evaluated from the set of relevant data;
a transformation processor, intended to transform the data to be evaluated by generating the data structure; and
a conference rule memory.

29. A program, adapted to perform the method of claim 1, when executed on a computer.

30. A computer readable medium, storing the program of claim 29.

31. A program, adapted to perform the method of claim 25, when executed on a computer.

32. A computer readable medium, storing the program of claim 31.
